(19) United States
(12) Patent Application Publication
(10) Pub. No.: US 2006/0101704 A1
(43) Pub. Date: May 18, 2006

(54) ROTATABLE ROD GRIP

(76) Inventor: IHAB (AHAB) AYOUB, Houston, TX (US)

Correspondence Address: IHAB (AHAB) AYOUB, 2210 WEST DALLAS, APT 1632, HOUSTON, TX, 77019, US

(21) Appl. No.: 11/164,312

(22) Filed: Nov. 17, 2005

Related U.S. Application Data
(60) Provisional application No. 60/522,902, filed on Nov. 18, 2004.

(51) Int. Cl. A01K 87/08; A01K 87/00

(52) U.S. Cl. 43/23; 43/25

(57) ABSTRACT

A rod grip that may rotate around a fishing rod shaft is disclosed The amount of rotation may vary, and the rod grip may be rotationally locked to the fishing rod, or some component thereof, when rotation of the rod grip is not desired. A fishing rod is also disclosed, having such a grip. A manufacturing method is disclosed for the manufacture of a rotatable rod grip and a fishing rod having such a grip. The grip may be retrofit onto existing fishing rods, whether or not they include an existing traditional grip. Lubricant, ball bearing, roller bearings and other approaches to relative movement may be used to facilitate the rotation of the disclosed grip.

### CROSS-REFERENCE TO RELATED APPLICATIONS

This application claims priority to U.S. Provisional Application No. 60/522,902, filed Nov. 18, 2004, and hereby incorporated by reference in its entirety.

### BACKGROUND OF INVENTION

The invention relates generally to a rotatable grip for a fishing rod.

### BACKGROUND ART

Fishing rods are one of the most common devices used by recreational and commercial fishermen alike for capturing fish and other marine organisms. As shown in FIG. 1, a fishing rod (or “rod”) typically will include a number of components, including a rod shaft 2, a lower or butt section 4 (the “rod butt” or “butt”), a grip section 6, and one or more guides 8 disposed along the upper section of the rod. The grip section 6 is usually disposed near and/or in the butt section 4 and typically comprises a lower grip 10 (nearer the butt end 12) and an upper grip 14, with a reel seat 16 disposed therebetween. The butt end 12 may also include a notch 13 or similar configuration for operatively connecting with a gimbal, gimbal pin, and/or other stabilizing device (not shown). A butt end 12 having a notch 13 or similar configuration disposed therein is typically referred to as a gimbal butt. Certain fishing rods may also include a bent butt configuration.

A reel 18 may be reversibly connected to the reel seat 16 and line 20 from the reel 18 will extend through one or more guides 8 positioned along the shaft 2. The shaft 2 typically comprises a rod blank (a relatively flexible elongate member) that may be continuous along the entire length of the fishing rod, or that may comprise separate sections that are either permanently or reversibly connected to one another, and/or to a separate elongate member disposed in the grip section 6. Either the rod blank, or the separate elongate member to which it is operatively connected, may provide a substrate for attachment of the grip 10,14.

Styles of rods vary widely, but they may be broken down into two popular categories. The first of these is for use with conventional reels, and is designed to be used with the reel 18 and guides 8 oriented above the rod (bottom configuration of FIG. 1). The second popular category of rod is designed for use with spinning reels. Such rods are typically used such that the reel 18 and guides 8 are oriented below the rod during use (top configuration of FIG. 1).

A third, less-common type of rod (not shown) foregoes the use of most or all guides 8 and instead includes a hollow disposed within the rod shaft 2. Line 20 is run through the hollow by means of an opening located near the reel 18 and exits the hollow through a second opening, disposed near the rod tip.

Regardless of rod type, fishing rods are used in a similar manner. Fishing line 20 is typically stored on the reel 18 when not in use. In use, a length of fishing line 20 is released from the reel 18, passes through one or more guides 8 (or a hollow disposed within the rod shaft 2) and enters the water (not shown). Upon hooking a fish, line 20 is retrieved back onto the reel 18 by cranking a handle that rotates a spool of the reel 18.

During use of a fishing rod, an operator will often “pump” the rod, raising and lowering it to exert pressure on a fish, and/or facilitate the retrieval of the fishing line 20. As shown in FIG. 2, during pumping, vertical rod movement typically will occur relative to a pivot point P. Although the pivot point P is indicated in FIG. 2 as being at the butt end 12 of the rod, the pivot point P may occur at various locations along the length of the rod, depending on use and orientation. Often, the butt end 12 will be stabilized by interfacing with a gimbal (not shown) or placing it against a relatively stable surface, such as some portion of the operator's body. A gimbal butt may be used with a gimbal having a gimbal pin to provide rotational stability as the rod pivots. In some instances, pumping of the rod may continue for long periods of time and operator fatigue may affect the likelihood of landing of a hooked fish.

As shown in FIG. 3, vertical displacement of the rod during use will typically result in rotational movement of the rod shaft 2 and reel 18 (about the longitudinal axis of the fishing rod) and will affect the orientation of the line 20 as it passes through the guides 8. When a rod is pumped during use, a certain amount of rotational movement will typically result because the operator's arm (as indicated generally at A) will not be in the same plane as the longitudinal axis of the rod. In a lowered position, the reel 18 may be in a relatively horizontal orientation (bottom configuration). As the rod is raised with respect to a pivot point (P in FIG. 2), the reel 18 will be rotationally displaced about the longitudinal axis of the rod (top configuration).

Rotation of the rod during use is often undesirable for a number of reasons. First, if a rod is used with a gimbal or other stabilizing device, such as may be disposed in a fighting chair or fighting belt, rotational movement of the rod may be restricted by gimbal and/or gimbal pin interaction with the butt end 12 of the rod and/or notch 13 disposed therein. In such a situation, the operator will experience resistance in the operation of the rod due to the resistance to rotation from the gimbal and/or gimbal pin, or the rod may detach from the gimbal and/or gimbal pin, thereby becoming unstable. If rotation of the rod is restricted, such as may occur when an operative connection to the gimbal pin is maintained during use, the operator will find that maintaining a hold on the grip 6 while the rod is pumped requires that the operator's hand rotate with the grip 6 instead of moving naturally with the operator's arm, often while the rod is under pressure. This may result in increased fatigue and possible injury to the operator's wrist.

Second, rotational motion of a rod during use will often result in the sliding of the line 20 along an inner circumference of one or more guides 8. Such interaction between line 20 and guide 8 increases the chance of line breakage due to increased friction. Imperfections in the typically smooth inner circumference of the guides 8 will also contribute to the likelihood of breakage during rotational interaction between line 20 and guide 8. Furthermore, certain rods may include roller guides, which require a particular orientation of the line as it passes through the guide. Displacement of the line within a roller guide may result in line breakage.

Third, energy is wasted during the operation of a rotating rod. For instance, when the rod is under pressure, a certain amount of energy is expended by the operator to maintain a tight hold on the grip 6 of the rod and to resist the pressure exerted on the rod. Rotation of the grip 6 in conjunction with the rod exerts an additional force against the operator's hold.

Fourth, many reels, particularly those lacking a line-winding device (often known as a level-wind mechanism) require that the operator direct the line onto the spool. Rotational movement of the reel 18 will make this task more difficult.

Fifth, rotation of the rod and attached reel 18 will result in movement of the handle of the reel 18 during use. This movement will make it more difficult for an operator to maintain a grip on the handle and will also require that the operator's hand change orientation as the rod is used, possibly resulting in increased fatigue and/or injury to the wrist.

Finally, as the rod is raised and lowered by the operator and rotation occurs, the orientation of force along the longitudinal axis of the rod will change during rotation. This may cause undesirable strain upon the rod.

For at least these reasons, there is a need for a rod grip that is rotatable about the longitudinal axis of a rod.

### SUMMARY OF INVENTION

In one aspect, the invention comprises a grip for a fishing rod, including a first member disposed such that a rotational interface is formed between the first member and a shaft of the fishing rod.

In one aspect, the invention comprises a fishing rod having a first member disposed such that it is rotatable about the longitudinal axis of the fishing rod.

In one aspect, the invention comprises a method for manufacturing a fishing rod, including the disposing of a first member about the shaft of the fishing rod and the disposing of a rotational interface between the first member and a shaft of the fishing rod.

Other aspects and advantages of the invention will be apparent from the following description and the appended claims.

### DEFINITIONS

As used herein with respect to relative movement, the term “about” has a preferred meaning of “along some circumference of, but not necessarily proximal to or in contact with.” “Some circumference of” includes any portion of a circumference, as well as an entire circumference. Circumference refers to an external boundary or perimeter of an object, which may be, but is not required to be, circular. Other definitions of “about” that do not depart from the spirit of the invention may also apply.

As used herein, the term “gimbal” has a preferred meaning of “a device for stabilizing an object in three-dimensional space.” A gimbal need not be in a fixed position, and in fact may pivot in various directions. A gimbal may also include a “gimbal pin” that may operatively connect to a notch or similar configuration in a fishing rod to provide additional (typically rotational) stability. Gimbals are often disposed on fighting chairs and fighting belts. Other meanings of the term “gimbal” that do not depart from the spirit of the invention may also apply.

### BRIEF DESCRIPTION OF DRAWINGS

FIG. 1 shows two embodiments of prior art fishing rods.

FIG. 2 shows two typical orientations of a prior art fishing rod.

FIG. 3 shows two typical orientations of a reel used in conjunction with a prior art fishing rod.

FIG. 4 shows a rotatable rod grip according to one embodiment of the invention.

FIG. 5 shows a rotatable rod grip according to one embodiment of the invention.

FIG. 6 shows a rotatable rod grip according to one embodiment of the invention.

FIG. 7 shows a rotatable rod grip according to one embodiment of the invention.

FIG. 8 shows a rotatable rod grip according to one embodiment of the invention.

FIG. 9 shows a rotatable rod grip according to one embodiment of the invention.

FIG. 10 shows a rotatable rod grip according to one embodiment of the invention.

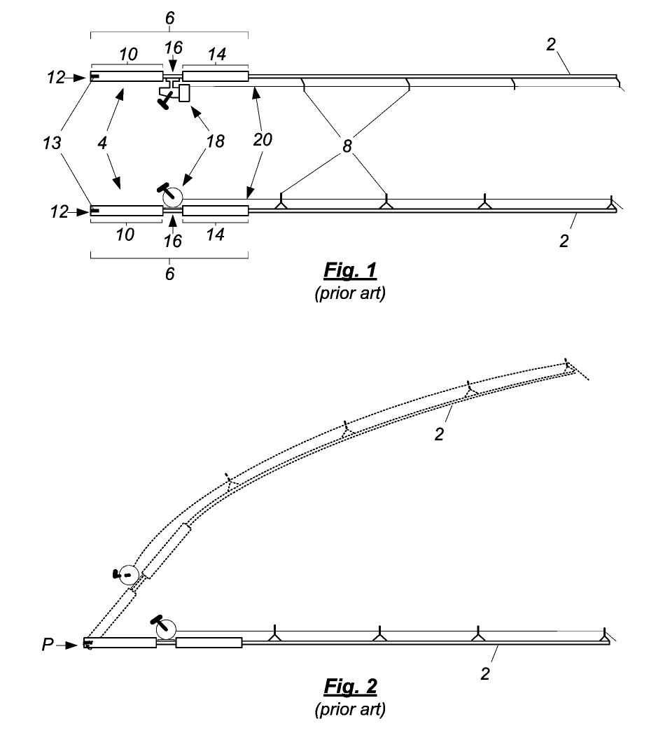

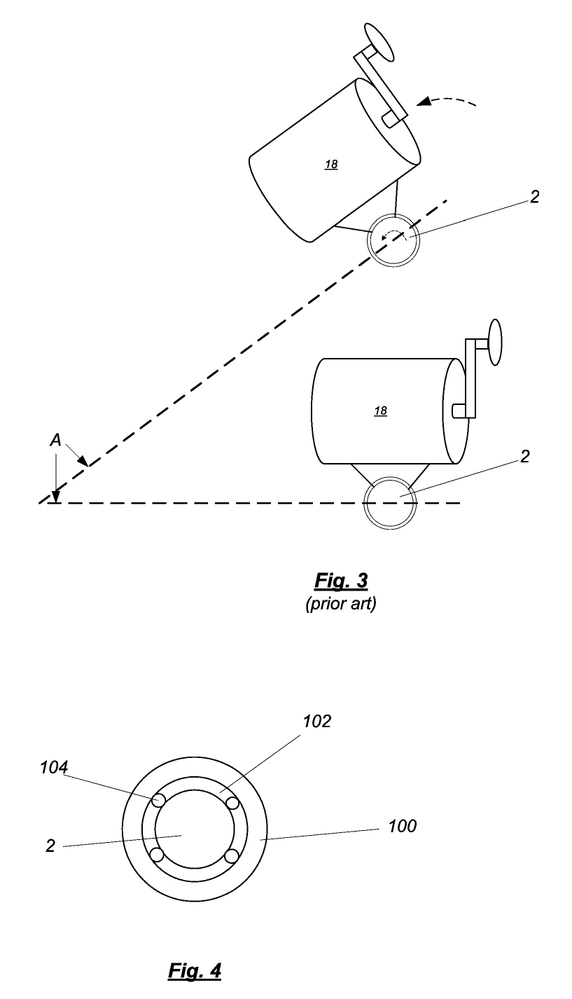

### DETAILED DESCRIPTION

As shown in FIG. 4, one embodiment of the invention comprises a first member 100 disposed along the circumference of a section of a fishing rod shaft 2. A rotational interface 102 between the first member 100 and shaft 2 permits rotation of the first member 100 about the longitudinal axis of the shaft 2. One or more rotational elements 104 may be disposed within the rotational interface 102 to facilitate rotation. A rotational element 104 may be of any type known in the art including, but not limited to, lubricants, ball bearings, and roller bearings. Rotation of the first member 100 about the shaft 2 may also be achieved by any other means known in the art.

In one embodiment, rotation of the first member 100 may be limited to a predetermined range. Furthermore, it may be desirable to provide a predetermined ease of rotation such that the first member 100 will not rotate of its own accord. It may also be desirable to bias the first member 100 such that it will maintain a predetermined rotational orientation unless rotated from that position by an operator.

The first member 100 may comprise plastic, metal, wood, or any other material known in the art, and/or any combination thereof. Furthermore, at least a portion of an outer surface of the first member 100 may comprise, and/or be covered or coated with an elastomeric material. The first member 100 may also comprise and/or be covered or coated with any other material known in the art. In one embodiment, such material may be selected on the basis of comfort for an operator's grip. In one embodiment, such material may be selected on the basis of non-skid or similar properties that will minimize slippage of an operator's grip. Durability may also play a role in the selection of an appropriate material. The inner surface of the first member 100 and/or outer surface of the shaft 2 may be configured to accommodate one or more rotational elements 104. The first member 100 may also be configured to allow for maintenance, replacement, and/or replenishment of any rotational elements 104 disposed in the rotational interface 102.

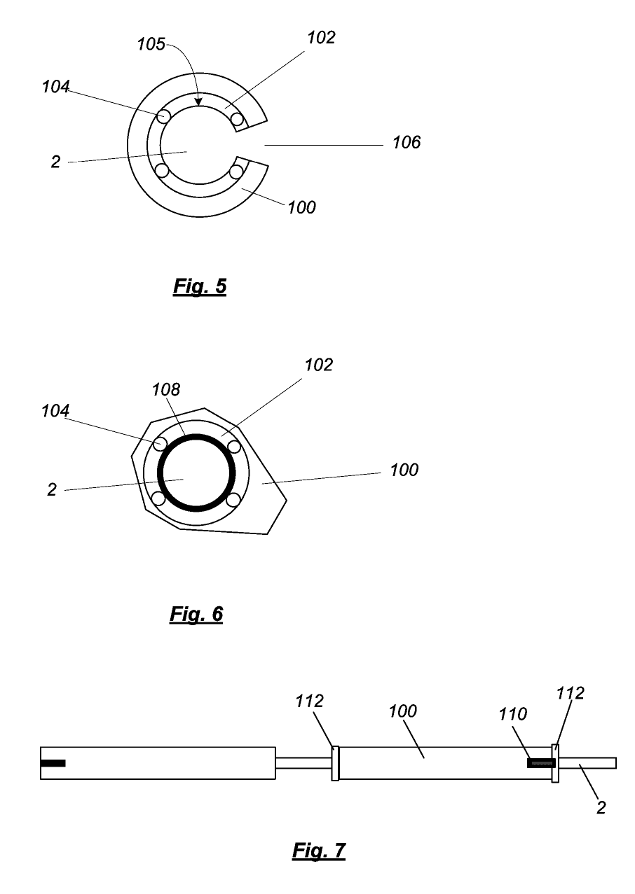

FIG. 5 shows one embodiment of a rotatable rod grip. In this embodiment, the first member 100 is not disposed about the entire circumference of the shaft 2. Instead, there is an opening 106 in the outer perimeter of the first member 100 that may facilitate a reversible or permanent operative connection of the first member 100 and shaft 2. For instance, if the first member 100 comprises a flexible material, it may be snapped onto the shaft 2. The opening 106 may be of any configuration known in the art. The rotational interface 102 may be operatively connected to the first member 100 by any means known in the art, and may include a sealing member 105 to retain and/or protect one or more rotational elements 104. The operative connection between the first member 100, rotational interface 102, and sealing member is preferably such that the first member 100 is rotatable with respect to the sealing member 105 such that when a rod shaft 2 is disposed within the embodiment, the sealing member 105 is operatively non-rotatably connected to the shaft, while the first member 100 is rotatable with respect to the shaft 2.

In the embodiment of FIG. 6, the rotatable rod grip includes a second member 108 that is disposed along at least a portion of the circumference of a predetermined section of the shaft 2. The second member 108 is operatively connected to the shaft 2 such that rotational movement between the second member 108 and shaft 2 is minimized. This may be achieved through the use of adhesives, texturing of the outer surface of the shaft 2 and/or inner surface of the second member 108, or any other means known in the art. The rotational interface 102 between the second member 108 and first member 100 may include one or more rotational elements 104.

The second member 108 may also include an opening to correspond to that of a first member 100, as shown in FIG. 5. Such an opening need only be aligned between the two members 100,108 during connection or removal of the grip and will not necessarily be aligned during operation. In such a configuration, either or both members 100,108 may be configured to retain any rotational elements 104 within the rotational interface 102 (i.e., configured so that any rotational elements are relatively protected).

As shown in FIG. 6, the outer perimeter of the first member 100 need not be circular, or even symmetrical. Instead, the outer perimeter of the first member 100 may be configured to be comfortable and/or to provide a more secure hold for an operator. In one embodiment, the first member 100 is configured to provide an ergonomic grip. One advantage of a rotatable rod grip is the facilitation of the use of an ergonomic configuration, which may be less feasible where the grip is rotationally fixed to a rod which may rotate during use.

As shown in the embodiment of FIG. 7, the first member 100 of a rotatable rod grip may include a switch 110 or similar device that may be manipulated by an operator. When the switch 110 is manipulated, rotation of the first member 100 about the longitudinal axis of the fishing rod may be prevented or limited to a desired range. The switch 110 and its operation may be of any type known in the art.

In one embodiment, one or more stops 112 may be disposed at predetermined locations so that movement or slippage of the first member 100 along the longitudinal axis of the shaft 2 is prevented. In one embodiment, such stops 112 may also function as a seal to prevent the entry of undesirable elements into the rotational interface 102 and/or the exit of one or more rotational elements 104 (not shown in FIG. 7). In one embodiment, the switch 110 may interact with one or more stops 112, the shaft 2, and/or a second member 108 (not shown in FIG. 7) to prevent or hinder rotation of the first member 100 about the longitudinal axis of the shaft 2. The switch 110 and stop 112 may comprise any material and/or configuration known in the art.

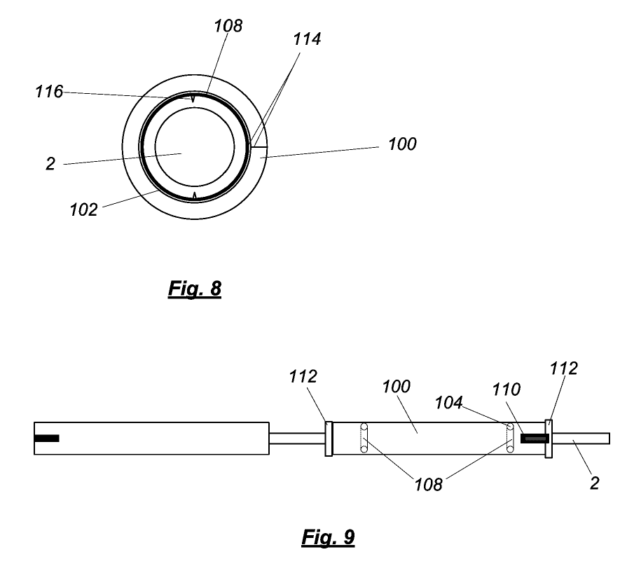

FIG. 8 shows one embodiment of a rotatable rod grip. In this embodiment, the first member 100 and second member 108 each include at least one seam 114 so that they may be at least partially opened to allow for the disposition of a rod shaft 2, possibly including an existing grip 6, inside the first member 100. In one embodiment, the first member 100 and second member 108 will include a plurality of seams 114 such that the two members 100,108 may be separated into a plurality of component parts that may be reversibly assembled about the shaft 2. One or more anti-rotational elements 116 may be disposed along an inner circumference of the second member 108 and may operatively connect with the shaft 2 or an existing grip 6 to prevent or hinder rotation of the second member 108 relative to the shaft 2. A rotational interface 102 is disposed between the first member 100 and second member 108 so that the first member 100 may rotate about the shaft 2.

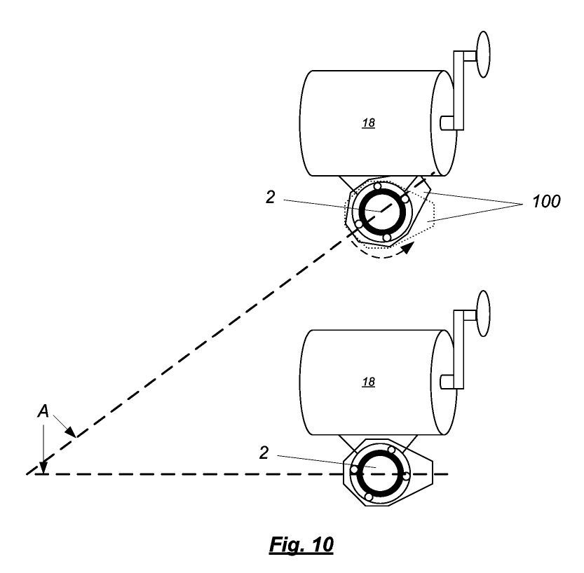

As shown in FIG. 9, the second member 108 need not match the first member 100 in length, quantity, and/or location. Instead, one or more second members 108 may be disposed at predetermined locations along the shaft 2. One or more rotational interfaces 102 (not labeled in FIG. 9) are disposed between the plurality of second members 108 and one or more first members 100. Rotational elements 104 may be disposed in each rotational interface 102.

As shown in FIG. 10, one advantage of various embodiments of the invention is the ability of the first member 100 to rotate about the longitudinal axis of a shaft 2 such that the shaft 2 and reel 18 may remain rotationally stable during operation of the fishing rod. The rotatability of the first member 100 facilitates the use of an ergonomic and/or asymmetrical grip, because it can rotate in conjunction with the rotation of an operator's hand.

Further advantages of a rotatable rod grip according to various embodiments of the invention include, but are not limited to, greater comfort for an operator, decreased stress on the operator and/or fishing rod during use, decreased line wear, possibility of retrofit to traditional grips and fishing rods, increased stability of the rod-particularly during use with gimbals or other stabilizing devices, conservation of energy (increased efficiency), and decreased risk of injury to the operator.

While the invention has been described with respect to a limited number of embodiments, those skilled in the art, having benefit of this disclosure, will appreciate that other embodiments can be devised which do not depart from the scope of the invention as disclosed herein. Examples of other embodiments include, but are not limited to, use of a rotatable rod grip with various embodiments of fishing rods, the use of various materials and substitutes for the components disclosed herein, limitations on the range and/or ease of rotation, variations in the number and placement of the various components described herein, and of the location of the rotatable grip. Furthermore, the degree of rotation of the rotatable rod grip may also vary and may be adjustable. In one embodiment, a range of rotation may be set by an operator. In on embodiment, the rotational interface 102 need not be circular, but may instead be polygonal. Accordingly, the scope of the invention should be limited only by the attached claims.

What is claimed is:

1. A grip for a fishing rod, comprising:
a first member configured to be disposed along a predetermined section of a shaft of the fishing rod; and
a rotational interface configured to be at least partially disposed between the first member and the shaft.

2. The grip of claim 1, further comprising a second member configured to be disposed between the rotational interface and the shaft.

3. The grip of claim 2, wherein the second member is configured to be rotationally fixed with respect to the shaft, and is operatively connected to the first member such that the first member is rotatable with respect to the second member.

4. The grip of claim 1, wherein at least one rotational element is disposed in the rotational interface.

5. The grip of claim 1, wherein the first member further comprises at least one selected from an opening and a seam.

6. The grip of claim 2, wherein the first member and the second member each further comprise one selected from an opening and a seam.

7. The grip of claim 1, wherein the first member at least partially comprises at least one selected from an elastomeric material, and an ergonomic configuration.

8. The grip of claim 1, wherein an elastomeric material is disposed on at least a portion of the first member.

9. The grip of claim 2, wherein the second member further comprises at least one anti-rotational element.

10. A fishing rod, comprising:
a longitudinal shaft;
a first member disposed along at least a portion of a circumference of a predetermined section of the longitudinal shaft; and
a rotational interface disposed between the first member and the longitudinal shaft.

11. The fishing rod of claim 10, further comprising a second member disposed between the first member and the longitudinal shaft such that the second member is rotationally fixed to the shaft and the rotational interface is disposed between the first member and the second member.

12. The fishing rod of claim 11, wherein the first member and the second member each include at least one selected from an opening and a seam.

13. The fishing rod of claim 10, wherein at least one rotational element is disposed in the rotational interface.

14. The fishing rod of claim 11, wherein the second member further comprises at least one anti-rotational element.

15. The fishing rod of claim 10, further comprising at least one stop for limiting the movement of the first member along a longitudinal axis of the shaft.

16. The fishing rod of claim 10, further comprising at least one switch for limiting the range of rotation of the first member.

17. A method of manufacturing a fishing rod, comprising:
providing a longitudinal shaft; and
disposing a first member at a predetermined location on the longitudinal shaft such that a rotational interface is formed between the first member and the longitudinal shaft.

18. The method of claim 17, further comprising disposing at least one second member in at least one predetermined location on the longitudinal shaft, such that the rotational interface is disposed between the first member and the second member.

19. The method of claim 17, further comprising disposing at least one rotational element in the rotational interface.

20. The method of claim 17, further comprising disposing at least one stop in at least one predetermined location on the longitudinal shaft.
